(19) United States
(12) Patent Application Publication
(10) Pub. No.: US 2024/0418910 A1
(43) Pub. Date: Dec. 19, 2024

(54) LENS MODULE WITH INTEGRATED STRUCTURE

(71) Applicant: PLATINUM OPTICS TECHNOLOGY INC., Taoyuan City (TW)

(72) Inventors: Shih-Song Cheng, Taoyuan City (TW); Bo-Xun Zhu, Taoyuan City (TW); Jia-Cheng Chang, Taoyuan City (TW); Kuan-Yu Chen, Taoyuan City (TW); Hung-Han Duan, Taoyuan City (TW); Shi-Lin Zhang, Taoyuan City (TW); Chin-Jung Hsu, Taoyuan City (TW)

(73) Assignee: PLATINUM OPTICS TECHNOLOGY INC., Taoyuan City (TW)

(21) Appl. No.: 18/743,911

(22) Filed: Jun. 14, 2024

(30) Foreign Application Priority Data
Jun. 16, 2023 (TW) 112122739

(51) Int. Cl. G02B 5/00

(52) U.S. Cl. CPC G02B 5/003

(57) ABSTRACT

Provided is a lens module with an integrated structure, including a first lens and a second lens, a first substrate and a second substrate, an optical bonding layer, a first absorption layer and a second absorption layer, wherein the first absorption layer includes a copper complex, which is formed from a copper compound, a phosphonic acid represented by formula 1 herein, and at least one phosphorus-containing compound represented by formulas 2 to 4 herein. Due to the integrated structure, the lens module can be reduced in size. The manufacturing process is simplified because no assembly process is required. The lens module of the present disclosure exhibits high transmittance for visible light and low transmittance for near-infrared, showing an excellent near-infrared cut-off effect. In addition, while the incident light irradiates the lens module at different angles, the transmittance curve only is slightly shifted.

### CROSS-REFERENCE TO RELATED APPLICATION

This application claims the benefit of priority of Taiwan Patent Application No. 112122739, filed Jun. 16, 2023, the entire contents of which are hereby incorporated by reference.

### BACKGROUND

### Technical Field

The present disclosure relates to a lens module, especially to a lens module with an integrated structure integrating the components separately disposed in the lens module.

### Description of Associated Art

A well-known camera lens module comprises multiple components, for example, including a lens, a filter, a photosensitive element, etc., among which a photosensitive element can be designed to sense lights at different wavelengths and thus to find various applications, for example, to sense infrared rays (for 3D sensing), visible light (for a general camera or a video camera), ultraviolet rays (for a lidar lens of a self-driving car) and X rays (for a digital X ray machine without films).

For application in a general camera or a video camera, a photosensitive element primarily senses in the range of visible light and a part of near-infrared rays; however, it is desirable to sense visible light only since near-infrared rays are considered as interference on images. In this regard, a separate filter having a high absorbance for near-infrared rays and high transmittances for light at other wavelengths is typically disposed on the incident side of a camera lens module, thereby achieving the purpose of filtering near-infrared rays off. However, the transmittance of current filters shifts upon a change in the incident angle of light with the degree of shift in positive correlation to the incident angle, resulting in the possibility of generating color shift when incident light is at a large angle and even making a misjudgment on values in the detection device. Therefore, it is desirable to maintain consistent optical properties even if the incident angle changes.

In addition, a camera lens module is required to increase volume due to the space for a filter. On the other hand, a lens in a camera lens module usually refers to a lens group comprising a series of lenses, and its focal length is adjusted by a focusing motor to focus light on a photosensitive element for imaging. With the market demands for diverse image modes and increasingly higher image quality, the number and thickness of lenses in a lens group may increase and lead to a larger size of a camera lens module, but this goes against the tendency of device miniaturization. The issue in the size of a camera lens module has been reflected in mobile phones, and it can be seen that there is a common situation for mobile phones to have a camera lens protruding outward, even for high-end mobile phones, which increases the risk of collision, damage, and others.

### SUMMARY

Given the problems mentioned above, the present disclosure provides a lens module comprising an integrated structure, comprising:
a first lens and a second lens on the outermost sides of the lens module, respectively;
a first substrate and a second substrate disposed on the first lens and the second lens, respectively;
an optical bonding layer disposed on the first substrate or the second substrate and between the first substrate and the second substrate; and
a first absorption layer and a second absorption layer disposed between the first substrate and the second substrate,
wherein the first absorption layer comprises:
a copper complex which is formed by a copper compound used for providing copper ions, a phosphonic acid represented by Formula 1, and at least one phosphor-containing compound represented by Formulas 2 to 4,

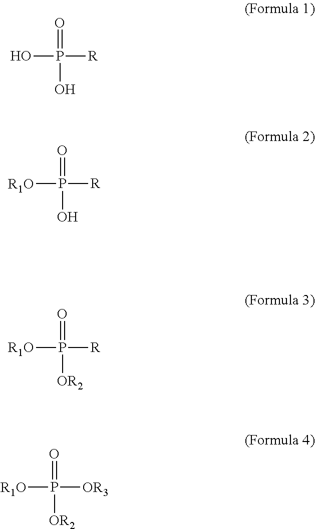

wherein R, R₁, R₂ and R₃ are each independently substituted or unsubstituted C₁-C₁₂ alkyl or substituted or unsubstituted C₆-C₁₂ aryl,
wherein the OD value of the first absorption layer for an incident light wavelength of 930-950 nm is greater than 4,
wherein the second absorption layer comprises an infrared absorption dye and an ultraviolet absorption dye.

In an embodiment, the substituted or unsubstituted C₁-C₁₂ alkyl is selected from the group consisting of methyl, ethyl, n-propyl, iso-propyl, n-butyl, sec-butyl, iso-butyl, tert-butyl; and the substituted or unsubstituted C₆-C₁₂ aryl is selected from the group consisting of phenyl, naphthyl and chlorophenyl.

In an embodiment, the first absorption layer has a haze of 0.4% or less.

In an embodiment, an X-ray photoelectron spectroscopy spectrum of the first absorption layer has at least one principal peak at binding energy of 930-940 eV. In a further embodiment, the at least one principal peak in the X-ray photoelectron spectroscopy spectrum of the first absorption layer has counts per second of 4500 or more.

In an embodiment, the first absorption layer has a thickness of 25-150 μm.

In an embodiment, the first absorption layer has minimum transmittance of 80% or more for an incident light wavelength of 460-560 nm. In a further embodiment, the first absorption layer has minimum transmittance of 85% or more for an incident light wavelength of 460-560 nm.

In an embodiment, the first absorption layer has maximum transmittance of 1% or less for an incident light wavelength of 830-1200 nm. In a further embodiment, the first absorption layer has maximum transmittance of 0.5% or less for an incident light wavelength of 830-1200 nm.

In an embodiment, the first absorption layer further comprises an optical resin. In a further embodiment, the optical resin is a thermoplastic resin and/or a photocurable resin. In a further embodiment, the optical resin is selected from polycarbonates, polyesters, polycycloolefins, polyacrylics, siloxane resins and polyimides. In a further embodiment, the optical resin is methyl methacrylate.

In an embodiment, the optical bonding layer is an optical adhesive tape or an optical clear adhesive.

In an embodiment, the first substrate and the second substrate are made of glass.

In an embodiment, the first lens and the second lens are made of materials selected from glass, polycarbonates and polyacrylates.

In an embodiment, the second absorption layer comprises at least a sublayer comprising an infrared absorption dye and at least a sublayer comprising an ultraviolet absorption dye.

In an embodiment, the near-infrared absorption dye is at least one selected from the group consisting of azo compounds, di-iminium compounds, benzene dithiol metal complexes, squaraine compounds, cyanine compounds and phthalocyanine compounds.

In an embodiment, the ultraviolet absorption dye is at least one selected from the group consisting of azomethylene compounds, indole compounds, ketone compounds, benzimidazole compounds and triazine compounds.

In an embodiment, the lens module of the present disclosure further comprises a spacer disposed on the first substrate or the second substrate and surrounding the optical bonding layer.

In an embodiment, the OD value of the lens module of the present disclosure for the incident light wavelength of 940 nm is greater than 4. In a further embodiment, the OD value of the lens module of the present disclosure for the incident light wavelength of 940 nm is greater than 4.5.

In an embodiment, the lens module of the present disclosure has a haze of 0.5% or less.

In an embodiment, the lens module of the present disclosure has a maximum transmittance of 0.01% or less for the incident light wavelength of 930-950 nm. In a further embodiment, the lens module of the present disclosure has a maximum transmittance of 0.005% or less for the incident light wavelength of 930-950 nm.

In an embodiment, the lens module of the present disclosure has a minimum transmittance of 80% or more for the incident light wavelength range of 460-560 nm. In a further embodiment, the lens module of the present disclosure has a minimum transmittance of 85% or more for the incident light wavelength of 460-560 nm.

In an embodiment, the lens module of the present disclosure has a passband overlaid with the wavelength of 350-850 nm, and the central wavelength of the passband is in the wavelength of 350-850 nm.

In an embodiment, there is a shift in the central wavelength of the passband when incident light irradiates the lens module of the present disclosure at incident angles of 0° vs. 30°, and the shift is 1.4 nm or less. In an embodiment, there is a shift in the central wavelength of the passband when incident light irradiates the lens module of the present disclosure at incident angles of 0° vs. 35°, and the shift is 1.9 nm or less.

The lens module of the present disclosure has a reduced size due to the integrated structure and can be manufactured simply without assembling. The lens module of the present disclosure exhibits high transmittance for visible light and low transmittance for near-infrared rays, especially exhibits a superior absorption for near-infrared at the wavelength of 940 nm, thereby exhibiting an excellent cutoff effect on near-infrared ray. In addition, there is only a slight shift when incident light irradiates the lens module of the present disclosure at different angles.

### BRIEF DESCRIPTION OF THE DRAWINGS

FIG. 1 is a schematic diagram showing one exemplary structure of the lens module of the present disclosure.

FIG. 2 is a schematic diagram showing another exemplary structure of the lens module of the present disclosure.

FIG. 3 is the X-ray photoelectron spectroscopy spectrum of the first absorption layer in Preparation Example 1.

FIG. 4 is a graph showing the transmittance curves of three embodiments of blue glass, blue glass+second absorption layer, and blue glass+first absorption layer+second absorption layer.

FIG. 5 is a graph showing the transmittance curves of Example 1 and Comparative Example 1.

FIG. 6 is a graph showing the transmittance curves of Example 2 and Comparative Example 1.

FIG. 7 is a graph showing the transmittance curves of Example 3 and Comparative Example 1.

FIG. 8 is a graph showing the transmittance curves of Example 4 and Comparative Example 1.

FIG. 9 is a graph showing the OD values of Examples 1 to 4 for the incident light wavelength of 930 nm to 950 nm.

FIG. 10 is a graph showing the transmittance curves of Example 1 irradiated at incident angles of 0°, 30°, and 35°, respectively.

FIG. 11 is a graph showing the transmittance curves of Example 3 irradiated at incident angles of 0°, 30°, and 35°, respectively.

### DETAILED DESCRIPTION OF THE PREFERRED EMBODIMENTS

The following describes the implementation of the present disclosure through specific embodiments, a person having ordinary skill in the art can easily understand the scope and effect of the present disclosure based on the content recorded herein.

It should be noted that the structures, proportions, sizes, etc. shown in the drawings attached to this specification are only used to exemplify the content disclosed in the specification for the understanding and reading of people skilled in this art, and are not intended to limit the scope of the present disclosure. The present disclosure may also be implemented or applied as described in the various examples. It is also possible to modify or alter the following examples for carrying out the present disclosure without violating its spirit and scope, for different aspects and applications. One of skill in the art will appreciate that structural modifications, changes in proportions, or adjustments in size of the disclosed embodiments will fall within the scope of the technical content disclosed in the present disclosure without affecting the effects that can be produced and the purposes that can be achieved by the present disclosure. Any modification of the structure, change of the proportion relationship, or adjustment of the size, may be made without affecting the efficacy and purpose of the present disclosure and will fall within the scope of the present disclosure, should fall in the scope of the technical content disclosed in the present disclosure.

Meanwhile, terms such as “upper”, “first” and “second” recited in the specification are also used for clear description but not for defining the scope capable of being implemented by the present disclosure, the change or adjustment of their relative relationship without substantial alteration of the technical contents are also considered within the implementation scope of the present disclosure.

Unless stated otherwise, “comprising”, “containing” or “having” particular elements used herein means that other elements such as units, components, structures, regions, parts, devices, systems, steps and connection relationships can be also included rather than excluded.

Unless expressly stated otherwise, the singular forms “a”, “an” and “the” also include the plural forms, and the “or” and “and/or” can be used interchangeably herein.

The numeric ranges described herein are inclusive and combinable, and any value falling into the numeric ranges described herein can be used as the upper or lower limit to derive a subrange. For example, a numeric range of “25-200” should be understood to include any subranges between the endpoints 25 and 200, e.g., subranges of 25-150, 30-200, 30-150, etc. In addition, a value falling into each range described herein (e.g., between the upper and lower limits) should be considered to be included in the range described herein.

The lens module with an integrated structure of the present disclosure comprises a first lens and a second lens, a first substrate and a second substrates, an optical bonding layer, and a first absorption layer and a second absorption layers.

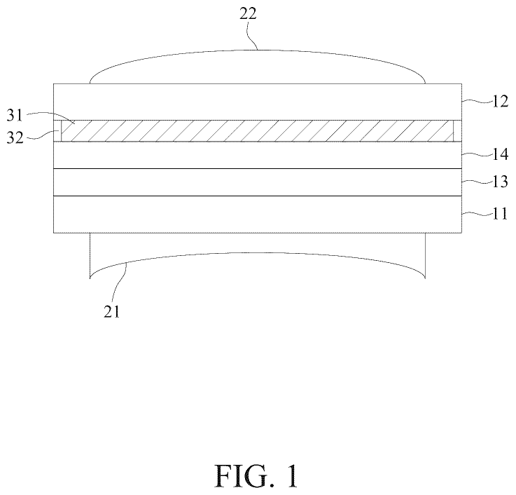

Firstly, referring to FIG. 1, which is a schematic diagram of the structure of the lens module of the present disclosure. In the integrated structure of the lens module: first lens 21 and second lens 22 are disposed on the outermost side, respectively; first substrate 11 and second substrate 12 are disposed on first lens 21 and second lens 22, respectively; optical bonding layer 31 is adhered to second substrate 12 and disposed between first substrate 11 and second substrate 12; and first absorption layer 13 and second absorption layer 14 are disposed between optical bonding layer 31 and first substrate 11. In this example, the layers from bottom to top are first lens 21, first substrate 11, first absorption layer 13, second absorption layer 14, optical bonding layer 31, second substrate 12, and second lens 22.

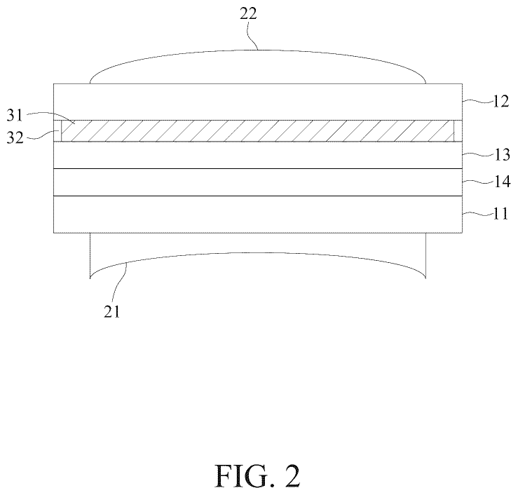

Further referring to FIG. 2, which is a schematic diagram of another structure of the lens module of the present disclosure and differs from FIG. 1 in that the position of first absorption layer 13 is interchanged with that of second absorption layer 14. In this example, the layers from bottom to top are first lens 21, first substrate 11, second absorption layer 14, first absorption layer 13, optical bonding layer 31, second substrate 12, and second lens 22.

As other examples, the optical bonding layer may otherwise be adhered to the first substrate.

As other examples, the lens module further comprises a spacer surrounding the optical bonding layer. As shown in FIGS. 1 and 2, optical bonding layer 31 is adhered to second substrate 12, and spacer 32 is also formed on second substrate 12 and surrounding optical bonding layer 31. In the case that the optical bonding layer may be adhered to the first substrate, the spacer is also formed on the first substrate and surrounding the optical bonding layer.

In an embodiment, the first absorption layer is a near-infrared absorption layer in which a copper complex having a near-infrared absorption function is included. The copper complex may be formed by a copper compound used for providing copper ions, a phosphonic acid represented by Formula 1, and at least one phosphor-containing compound represented by Formulas 2 to 4,

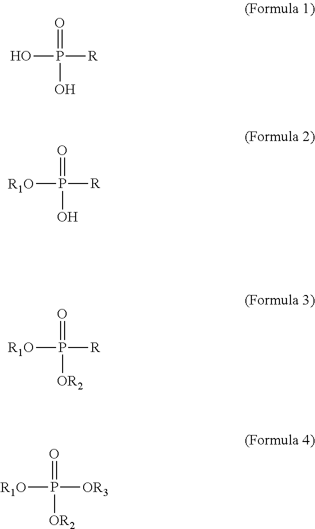

wherein R, R₁, R₂ and R₃ are each independently substituted or unsubstituted C₁-C₁₂ alkyl or substituted or unsubstituted C₆-C₁₂ aryl.

The copper complex may be presented by formula Cu²⁺X, wherein Cu²⁺ is provided by the copper compound; and X is contributed by a phosphonic acid and/or a phosphorus-containing compound.

The alkyl includes, but is not limited to, methyl, ethyl, n-propyl, iso-propyl, n-butyl, sec-butyl, iso-butyl, tert-butyl, pentyl, etc., and examples of the substituted alkyl includes, but is not limited to, haloalkyl, hydroxyalkyl, nitroalkykl, alkoxyalkyl, etc. The aryl includes, but not limited to, phenyl, nathphyl, etc., and examples of the substituted aryl includes, but not limited to haloaryl (e.g., chorophenyl), nitroaryl, hydroxyaryl, alkoxyaryl, haloalkylaryl, nitroalkylaryl, hydroxyalkylarykl.

In an embodiment, the phosphonic acid is butylphosphonic acid.

The copper compound is used mainly as a supply source of copper ions, and well known copper compounds may be employed for providing copper ions, such as copper salts, e.g., copper acetate or copper acetate hydrate, as well as anhydrides or hydrates of copper chloride, copper formate, copper stearate, copper benzoate, copper pyrophosphate, copper naphthenate, copper citrate. In an embodiment, the copper compound for providing copper ions is copper acetate.

The phosphorus-containing compound has a function of dispersion to make the components (including the copper complex formed) achieve uniform dispersing without agglutinating with each other. One effect of this function is to make a microcrystal size therein to be between 5 nm and 80 nm, or between 20 nm and 60 nm, e.g., 5, 10, 15, 20, 25, 30, 35, 40, 45, 50, 60, 70, 80, 90 or 100 nm or e.g., about 5, about 10, about 15, about 20, about 25, about 30, about 35, about 40, about 45, about 50, about 60, about 70, about 80, about 90 or about 100 nm. Sufficient near-infrared absorption property can be exhibited at a microcrystal size of 5 nm or more; while the product prepared has a relatively low haze due to the small number average particle size when the microcrystal size is 100 nm or less.

The copper complex can be prepared from a near-infrared absorption composition which comprises the copper compound, the phosphonic acid and the phosphorus-containing compound described above, and each component reacts with each other to form the copper complex. In the present disclosure, the proportion of each component can be adjusted as needed, for example, in the near-infrared absorption composition, the copper compound for providing copper ions maybe of 1-150 weight parts, such as 1, 5, 10, 15, 20, 25, 30, 35, 40, 45, 50, 55, 60, 65, 70, 75, 80, 85, 90, 95, 100, 105, 110, 115, 120, 125, 130, 135, 140, 145 or 150 weight parts; the phosphonic acid may be of 1-100 weight parts, such as 1, 5, 10, 15, 20, 25, 30, 35, 40, 45, 50, 55, 60, 65, 70, 75, 80, 85, 90, 95 or 100 weight parts; and the phosphorus-containing compounds may be of 1-90 weight parts in total, such as 1, 5, 10, 15, 20, 25, 30 35, 40, 45, 50, 55, 60, 65, 70, 75, 80, 85 or 90 weight parts.

In an embodiment, the near-infrared absorption composition comprises the phosphorus-containing compounds represented by Formulas 2 to 4 concurrently with the proportions can be adjusted as needed, for example, in the near-infrared absorption composition, the phosphorus-containing compound represented by Formula 2 may be of 1-90 weight parts, the phosphorus-containing compound represented by Formula 3 may be of 1-90 weight parts the phosphorus-containing compound represented by Formula 4 may be of 1-90 weight parts, wherein the phosphorus-containing compounds represented by Formulas 2 to 4 each may be, for example, of 1, 5, 10, 15, 20, 25, 30, 35, 40, 45, 50, 55, 60, 65, 70, 75, 80, 85 or 90 weight parts. In a further embodiment, the ratio of the phosphorus-containing compound represented by Formula 2: the phosphorus-containing compound represented by Formula 3: the phosphorus-containing compound represented by Formula 4 is 20:20:50.

In an embodiment, the near-infrared absorption composition may be the form of a dispersion, i.e., the near-infrared absorption composition further comprises a solvent in addition to the copper compound, the phosphonic acid and the phosphorus-containing compound. During formulation, the copper compound, the phosphonic acid and the phosphorus-containing compound may be added into the solvent and mixed, the ratio of those components to the solvent may be 1:5 to 1:1, such as 1:3, but not limited thereto.

The solvent may be selected from well-known solvents, including but not limited to, water, alcohols, ketones, ethers, esters, aromatic hydrocarbons, halogenated hydrocarbons, dimethylformamide, dimethylacetamide, dimethyl sulfoxide, sulfolane, etc. Specifically, the alcohols are, for example, methanol, ethanol, propanol, etc. The esters are, for example, alkyl formates, alkyl acetates, alkyl propionate, alkyl butyrate, alkyl lactate, alkyl alkoxyacetate, alkyl 3-alkoxypropionate, alkyl 2-alkoxypropionate, alkyl 2-alkoxy-2-methylpropionate, alkyl pyruvate, alkyl acetylacetate, alkyl 2-oxobutyrate, etc. The ethers are, for example, diethylene glycol dimethyl ether, tetrahydrofuran, ethylene glycol monomethyl ether, ethylene glycol monoethyl ether, methylcellosolve acetate, ethylcellosolve acetate, diethylene glycol monomethyl ether, diethylene glycol monoethyl ether, diethylene glycol monobutyl ether, propylene glycol monomethyl ether, propylene glycol monomethyl ether acetate, propylene glycol monoethyl acetate, propylene glycol monopropyl ether acetate, etc. The ketones are, for example, methyl ethyl ketone, cyclohexanone, cyclopentanone, 2-heptanone, 3-heptanone, etc. The aromatic hydrocarbons are, for example, toluene, xylene, etc.

The mixing is, for example, stirring thoroughly at room temperature (e.g., 25° C.), such as for 4 hours or more, 6 hours or more, 8 hours or more, but not limited thereto.

In the present disclosure, the near-infrared absorption composition in the form of a dispersion can be mixed with an optical resin to form a near-infrared absorption composition in the form of a coating solution for subsequent formation of the first absorption layer. The ratio of the dispersion to the optical resin may be 5:1 to 1:1, or 3:1 to 1:1, such as 0.65:0.35, but not limited thereto. The near-infrared absorption composition in the form of a coating solution is used to be applied onto a substrate and baked for curing, to form the first absorption layer.

The optical resin may be a thermoplastic resin and/or a photocurable resin. In an embodiment, the optical resin is selected from polycarbonates, polyesters, polycycloolefins, polyacrylics, siloxane resins and polyimides. In a further embodiment, the optical resin is a siloxane resin. In a further embodiment, the optical resin is methyl methacrylate.

In an embodiment, the near-infrared absorption composition may be added with other additives, e.g., initiator, such as a photoinitiator, and thereby the optical resin may be subjected to polymerization by light irradiation. The initiator includes, but not limited to, azodiisobutyronitrile. In an embodiment, the additive is, for example, a curing agent that facilitates the curing process. The curing agent is, for example, a photocuring agent, and thereby curing can be performed to form a film by light irradiation. In an embodiment, a solvent may also be added to facilitate uniform mixing. Well known solvents may be used as the solvent herein, including but not limited to, those mentioned herein.

In an embodiment, in order to maintain the better light transmittance, the first absorption layer has a haze of 0.4% or less, 0.3% or 0.2% or less, e.g., 0.4%, 0.35%, 0.3%, 0.25%, 0.2%, 0.19%, 0.18%, 0.17%, 0.16%, 0.15%, 0.14%, 0.13%, 0.12%, 0.11% or 0.1%.

The thickness of the first absorption layer also has an effect on the properties of near-infrared absorption. In general, the cutoff capability for near-infrared rays increases as the thickness of the first absorption layer increases, while the cutoff capability for near-infrared rays decreases as the thickness of the first absorption layer decreases. The first absorption layer of the present disclosure can achieve excellent cutoff capability for near-infrared rays even if its thickness is small. Specifically, the first absorption layer has a thickness between 25 μm and 150 μm, between 50 μm and 150 μm, or between 100 μm and 150 μm, e.g., 25 μm, 30 μm, 35 μm, 40 μm, 45 μm, 50 μm, 60 μm, 70 μm, 80 μm, 90 μm, 100 μm, 110 μm, 120 μm, 125 μm, 130 μm, 135 μm, 140 μm, 145 μm, 146 μm, 147 μm, or 150 μm.

In an embodiment, the X-ray photoelectron spectroscopy spectrum of the first absorption layer of the present disclosure has at least one principal peak at binding energy of 930-940 eV. In an embodiment, the at least one principal peak has counts per second of 4500 or more, 4600 or more, 4700 or more, 4800 or more, 4900 or more, or 5000 or more.

In an embodiment, for the incident light wavelength of 930-950 nm (including for the incident light wavelength of 940 nm), the first absorption layer of the present disclosure has maximum transmittance of 0.1% or less, less than 0.1%, 0.05% or less, less than 0.05%, 0.01% or less, less than 0.01%, 0.005 or less, or less than 0.005%, e.g., 0.1%, 0.09%, 0.08%, 0.07%, 0.06%, 0.05%, 0.04%, 0.03%, 0.02%, 0.01%, 0.009%, 0.0008%, 0.007%, 0.0006%, 0.005%, 0.004%, 0.003%, 0.002% or 0.001%. In another aspect, for the incident light wavelength ranging from 930-950 nm (including for the incident light wavelength of 940 nm), the OD value is 3 or more, more than 3, 3.5 or more, more than 3.5, 4 or more, more than 4, 4.5 or more, or more than 4.5, e.g., 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9.

In an embodiment, for the incident light wavelength of 830-1200 nm, the first absorption layer of the present disclosure has maximum transmittance of 1% or less or 0.5% or less, e.g., 1%, 0.9%, 0.8%, 0.7%, 0.6%, 0.5%, 0.4%, 0.3%, 0.2% or 0.1%; and for the incident light wavelength of 460-560 nm, the first absorption layer of the present disclosure has minimum transmittance of 80% or more or 85% or more, e.g., 80%, 81%, 82%, 83%, 84%, 85%, 86%, 87%, 88%, 89% or 90%.

In an embodiment, the first absorption layer has a passband overlaid with a wavelength of 300-850 nm, 300-800 nm, or 350-750 nm, and the central wavelength of the passband is in the wavelength of 300-850 nm, 300-800 nm, 350-750 nm, 400-700 nm, 450-650 nm, 500-600 nm, or 500-550 nm. Herein, “passband” refers to a range within which transmittance of 50% or more is exhibited for the incident light in the wavelength range, and “central wavelength of the passband” refers to an average value of the two incident light wavelengths corresponding to the 50% transmittance exhibited for incident light.

The second absorption layer is used for aiding the first absorption layer to allow the lens module with an integrated structure of the present disclosure to exhibit better optical properties, e.g., the second absorption further improves the cutoff on near-infrared rays and ultraviolet rays. In an embodiment, the second absorption layer comprises a near-infrared absorption dye and/or an ultraviolet absorption dye. In an embodiment, the second absorption layer comprises a plurality of sublayers including at least a sublayer comprising an infrared absorption dye and at least a sublayer comprising an ultraviolet absorption dye. In the case that the second absorption layer comprises a plurality of sublayers, the arrangement order of the near-infrared absorption dye layer and the ultraviolet absorption dye layer is not limited, for example, the near-infrared absorption dye layer may be disposed near the incidence side and the ultraviolet absorption dye layer may be disposed near the photosensitive side; or alternatively, the ultraviolet absorption dye layer may be disposed near the incidence side and the near-infrared absorption dye layer may be disposed near the photosensitive side.

In an embodiment, the second absorption layer has a thickness of 0.5-10 μm, e.g., 0.5 μm, 1 μm, 2 μm, 3 μm, 4 μm, 5 μm, 6 μm, 7 μm, 8 μm, 9 μm or 10 μm. If the second absorption layer is a multi-layered structure, each layer has a thickness of 0.5 μm to 10 μm, e.g., 0.5 μm, 1 μm, 2 μm, 3 μm, 4 μm, 5 μm, 6 μm, 7 μm, 8 μm, 9 μm to 10 μm.

In an embodiment, the second absorption layer may comprises a transparent resin including, but not limited to, one selected from epoxy resins, polyurethanes, polyacrylates, polyolefins, polycarbonates, polycycloolifins and poly(vinyl butyral), and the resin may be used as a substrate for the second absorption layer. In an embodiment, for visible light (e.g., wavelength of 460-560 nm), the transparent resin has average transmittance or minimum transmittance of 85% or more, preferably 90% or more, including, but not limited to, 85%, 86%, 87%, 88%, 89%, 90%, 91%, 92%, 93%, 94%, or 95%.

In an embodiment, the near-infrared absorption dyes may be, for example, azo compounds, di-iminium compounds, benzene dithiol metal complexes, squaraine compounds, cyanine compounds and phthalocyanine compounds, and can adjust the maximum absorption wavelength to be between 650 nm and 1100 nm, or more specifically between 650 nm and 750 nm. The ultraviolet absorption dyes may be, for example, azomethylene compounds, indole compounds, ketone compounds, benzimidazole compounds and triazine compounds.

The first substrate and the second substrate provide support to the first absorption layer, the second absorption layer, and the optical bonding layer, and can be used to aid the first absorption layer to exhibit better optical properties, as the second absorption layer described above, e.g., the first substrate and the second substrate may further improves the cutoff on near-infrared rays and ultraviolet rays. In an embodiment, the first substrate and the second substrate can be made of glass, specifically, can be made of transparent glass (e.g., AF glass) or blue glass, and the first substrate and the second substrate can exhibit the cutoff effect on near-infrared rays when blue glass is used. The blue glass is, e.g., phosphate glass, such as the blue glass formed from metaphosphate compounds, carbonate compounds, metal oxides and metal fluorides, wherein the metaphosphate compounds include, but not limited to, aluminum metaphosphate, magnesium metaphosphate, lithium metaphosphate, zinc metaphosphate, and calcium metaphosphate; the carbonate compounds include, but not limited to, calcium carbonate, barium carbonate, and strontium carbonate; the metal oxides include, but not limited to, copper oxide, aluminum oxide, zinc oxide, and magnesium oxide; and the metal fluorides include, but not limited to, aluminum fluoride, magnesium fluoride, calcium fluoride, strontium fluoride, barium fluoride, and zinc fluoride. The glass raw materials may be placed in a crucible after mixing uniformly, and the crucible is placed in an oven in atmosphere or reducing atmosphere while controlling the temperature between 700° C. and 1000° C. to yield homogenized glass.

In an embodiment, the first substrate and the second substrate are blue glass, wherein the molar ratio of P/(Al+La+Nb+Y) is 1.5-16, and the molar ratio of F/(F+O) is 0.01-0.2. In an embodiment, the blue glass comprises 35-55 mol % of phosphorus element, 3.5-15 mol % of aluminum element, 15-25 mol % of alkali metal elements, 10-35 mol % of alkali earth metals and divalent metals, 10-21 mol % of copper element, and 0-7 mol % of lanthanum+niobium+yttrium in total, and wherein the molar ratio of Cu/P is 0.25-0.7, and the molar ratio of F/(F+O) is 0.01-0.2.

In an embodiment, the thickness of the first and/or the second substrate is between 200 μm and 500 μm, between 200 μm and 400 μm, or between 200 μm and 300 μm, e.g., 200 μm, 225 μm, 250 μm, 275 μm, 300 μm, 325 μm, 350 μm, 375 μm, 400 μm, 425 μm, 450 μm, 475 μm, or 500 μm.

The first lens and the second lens may be of those materials, compositions and shapes well known in the art, which are not limited in the present disclosure and should be encompassed in the scope of the present disclosure as long as they can be integrated in the lens module with an integrated structure of the present disclosure. In an embodiment, the first substrate and the second substrate can be made of glass, polycarbonates, polyacrylates, etc.

The optical bonding layer can be of those materials and compositions well known in the art, which is not limited in the present disclosure and should be encompassed in the scope of the present disclosure as long as it can be adhered to the first substrate and the second substrate and the first and the second absorption layers thereon. In an embodiment, the optical bonding layer can be an optical adhesive tape or an optical clear adhesive. In an embodiment, the material of the optical bonding layer has a refractive index matched with that of the first substrate or the second substrate to which the optical bonding layer is adhered, to reduce the loss and refraction of incident light generated on the interface.

The spacer may be of those materials and compositions well known in the art which are not limited in the present disclosure. In addition to serving as the boundary of the optical bonding layer, the spacer can also be used as a cutting marker during mass manufacturing of the lens module of the present disclosure, such as during the process including coating, configuring, and cutting to large-area substrates (such as wafers) to produce a plurality of lens modules.

In an embodiment, the lens module of the present disclosure has a haze of 0.5% or less, 0.4% or less, or 0.3% or less, e.g., 0.5%, 0.45%, 0.4%, 0.35%, 0.3%, 0.25%, 0.2%, 0.19%, 0.18%, 0.17%, 0.16%, 0.15%, 0.14%, 0.13%, 0.12%, 0.11% or 0.1%.

In an embodiment, for the incident light wavelength of 930-950 nm (including for the incident light wavelength of 940 nm), the lens module of the present disclosure has maximum transmittance of 0.01% or less, less than 0.01%, 0.005% or less, or less than 0.005%, e.g., 0.01%, 0.009%, 0.008%, 0.007%, 0.006%, 0.005%, 0.004%, 0.003%, 0.002%, 0.001%; on the other hand, the OD values for the incident light wavelength of 930-950 nm (including for the incident light wavelength of 940 nm) is 4 or more, more than 4, 4.5 or more, more than 4.5, 4.8 or more, or more than 4.8, e.g., 4, 4.01, 4.1, 4.2, 4.3, 4.4, 4.5, 4.51, 4.6, 4.7, 4.8, 4.81, 4.9.

In an embodiment, for the incident light wavelength of 830-1200 nm, the lens module of the present disclosure has maximum transmittance of 1% or less or 0.5% or less, e.g., 1%, 0.9%, 0.8%, 0.7%, 0.6%, 0.5%, 0.4%, 0.3%, 0.2% or 0.1%; and for the incident light wavelength of 460-560 nm, the lens module of the present disclosure has minimum transmittance of 80% or more or 85% or more, e.g., 80%, 81%, 82%, 83%, 84%, 85%, 86%, 87%, 88%, 89% or 90%.

In an embodiment, the lens module of the present disclosure has a passband overlaid with a wavelength of 300-850 nm, 300-800 nm, or 350-750 nm, and the central wavelength of the passband is in the wavelength of 300-850 nm, 300-800 nm, 350-750 nm, 400-700 nm, 450-650 nm, 500-600 nm, or 500-550 nm.

In an embodiment, there is a shift in the central wavelength of the passband when incident light irradiates the lens module of the present disclosure at incident angles of 0° vs. 30°, and the shift is 1.4 nm or less, e.g., 1.4 nm, 1.3 nm, 1.2 nm, or 1.1 nm. In an embodiment, there is a shift in the central wavelength of the passband when incident light irradiates the lens module at incident angles of 0° vs. 35°, and the shift is 1.9 nm or less, e.g., 1.9 nm, 1.8 nm, or 1.7 nm.

### EXAMPLES

Further details will be described in the present disclosure by referencing to following exemplary Examples which are not intended to limit the scope of the present disclosure.

### EXAMPLES

Blue glass with a large area was used as a first substrate, the first absorption layer was formed on it, and then a second absorption layer was formed. Thereafter, a spacer was disposed on the second absorption layer to configure a spacer region. The spacer region was filled with an optical clear adhesive, and then was covered by the blue glass with a large area used as the first substrate. Resin layers were formed outside of the first substrate and the second substrate and treated to form the first lens and the second lens with particular shapes. Finally, a cutting step was performed to yield a lens module with an integrated structure.

### Preparation Example

### First Absorption Layer

150 Weight parts of copper acetate were mixed with 15000 weight parts of ethanol and stirred at room temperature for 1.5 hrs to form a first mixture. Additionally, 20 weight parts of the phosphorus-containing compound represented by Formula 2 (plysurf A242G, purchased from Daiichi Pharmaceutical Co., Ltd.), 20 weight parts of the phosphorus-containing compound represented by Formula 3 (plysurf W542C, purchased from Daiichi Pharmaceutical Co., Ltd.) and 50 weight parts of the phosphorus-containing compound represented by Formula 4 (plysurf A285C, purchased from Daiichi Pharmaceutical Co., Ltd.) were mixed with 1500 weight parts of ethanol to form a second mixture. The first and the second mixtures were mixed and stirred at room temperature for 1 hr, and then 100 weight parts of butylphosphonic acid were added and stirred at room temperature to react for 3 hrs. Thereafter, the reaction mixture was placed in an oven at 85° C. for 12 hrs to obtain powder. The powder was mixed with xylene at a weight ratio of 1:3 to form a dispersion, the dispersion was mixed with methyl methacrylate (MMA) at a weight ratio of 0.65:0.35 to form a coating solution, and the coating solution was coated on a substrate and baked at 70° C. for 30 minutes, yielding the first absorption layer.

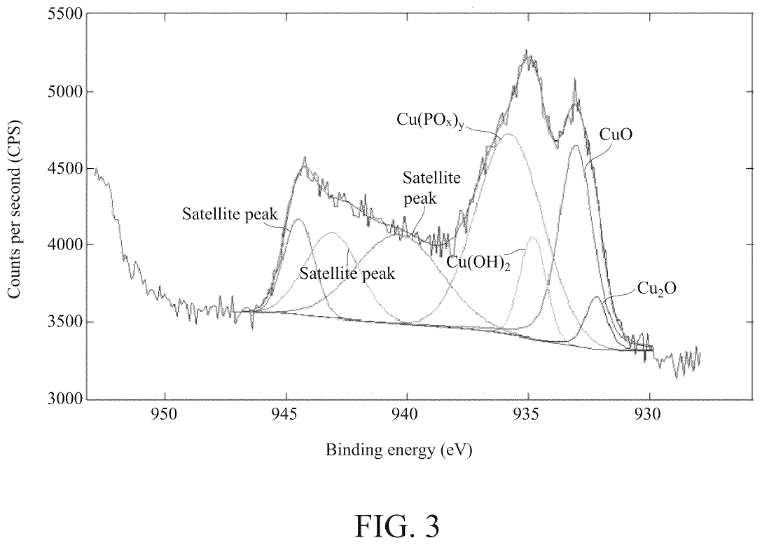

An X-ray photoelectron spectroscopy (ESCA/XPS) measurement was performed on the first absorption layer, and the X-ray photoelectron spectroscopy spectrum was shown in FIG. 3. Characteristic peaks related to the copper complex (Cu(POₓ)_{y}, CuO, Cu₂O, Cu(OH)₂) at binding energy of 930-940 eV were observed. Also, peaks occurred at binding energy of 940 eV or more were satellite peaks.

### Second Absorption Layer

0.02 g of squaraine compounds and cyanine compounds as infrared absorption dyes were added to 5 g of epoxy resin, and then the mixture was coated on a substrate and baked at 70° C. for 30 minutes to yield a sublayer containing the near-infrared absorption dyes. Additionally, 0.02 g of triazine compounds as a ultraviolet absorption dye was added to 5 g of epoxy resin, and then the mixture was coated on the sublayer containing the near-infrared absorption dye and baked at 70° C. for 30 minutes to yield a sublayer containing the ultraviolet absorption dye. Both of the sublayers were used as a second absorption layer.

### Comparison of Transmittance Cures

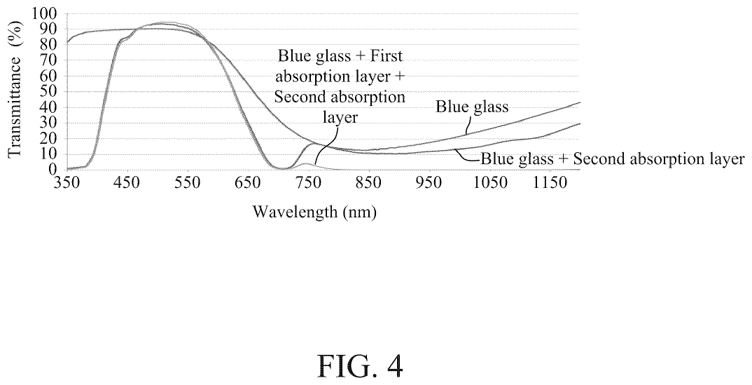

Firstly, a second absorption layer was prepared according to the method described in the Preparation Example 1 above, which comprised coating a first mixture on blue glass to form a sublayer containing a near-infrared absorption dye, then coating a second mixture on the sublayer to form a sublayer containing an ultraviolet absorption dye, thereby obtaining a bi-layered structure of blue glass+second absorption (containing two sublayers). A tri-layered structure of blue glass+first absorption layer+second absorption layer was further prepared according to the method for preparing the bi-layered structure, except that the second absorption layer was formed after forming the first absorption layer on blue glass by coating the coating solution. The transmittance curves of the blue glass, the bi-layered structure, and the tri-layered structure are shown in FIG. 4. It can be seen that the incorporation of the first absorption layer significantly improved the cutoff effect on near-infrared rays and maintained the high transmittance in the visible band.

### Example 1

The lens module was configured as shown in FIG. 1, in which first lens 21, second lens 22, first substrate 11 (blue glass) and second substrate 12 (blue glass), optical bonding layer 31 (optical adhesive tape), first absorption layer 13 (prepared according to the method described in Preparation Example 1 and having a thickness of 145.44 μm), and second absorption layer 14 (prepared according to the method described in Preparation Example 1 and having a thickness of 5 μm).

### Examples 2 to 4 and Comparative Example 1

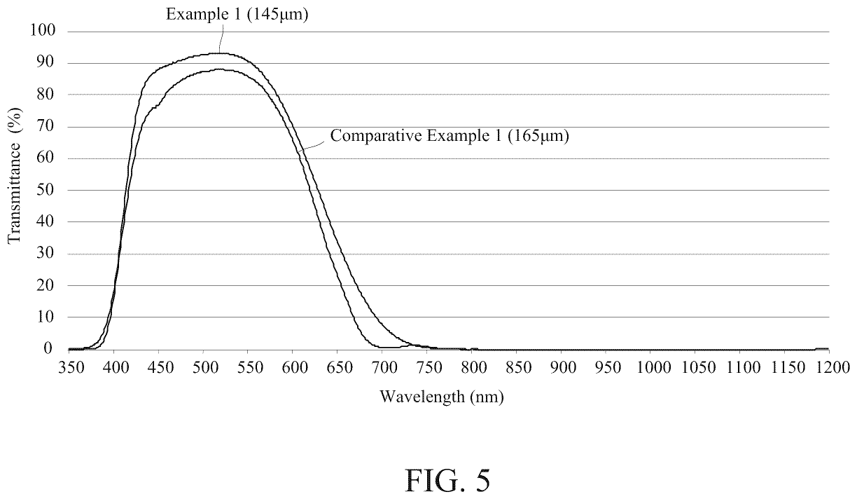

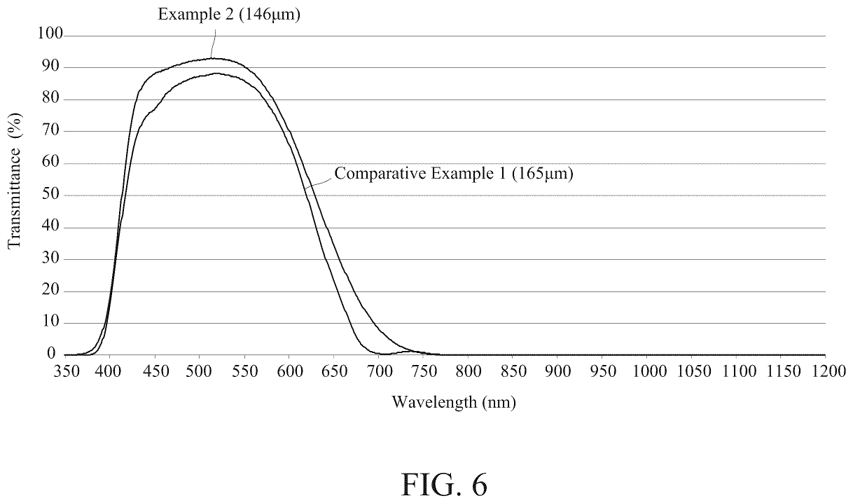

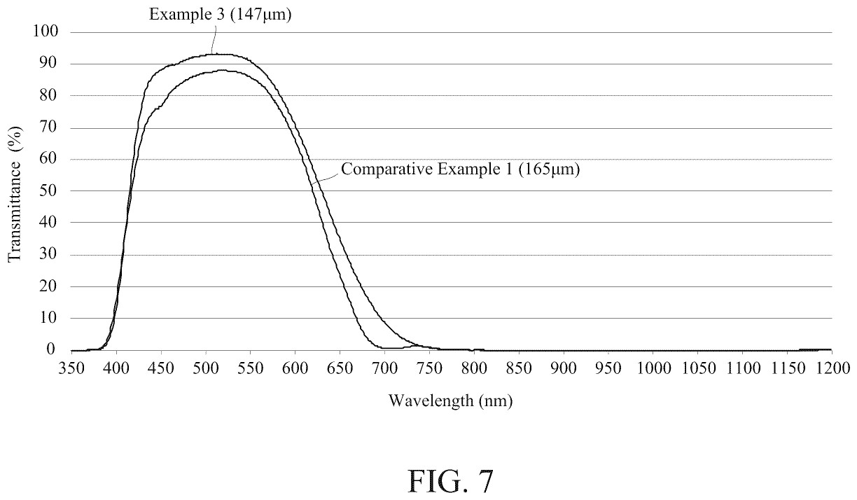

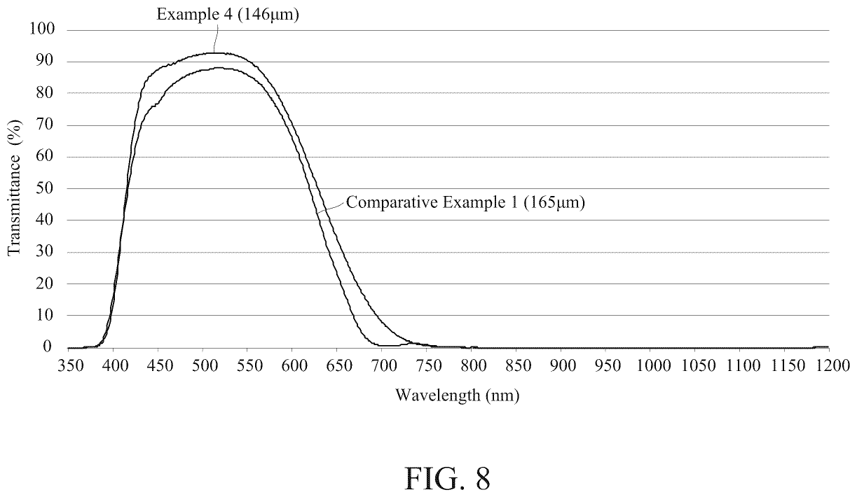

The lens modules were prepared according to the method of Example 1, except that the thickness of the first absorption layer was altered to be 146.22 μm, 147.44 μm, and 146.63 μm as Example 2 to 4, respectively. Additionally, a lens module was prepared according to the method of Example 1 as Comparative Example 1, except that the thickness of the first absorption layer was altered to be 165.11 μm. The transmittance curves of Examples 1 to 4 and Comparative Example 1 were shown in FIG. 5 to FIG. 8.

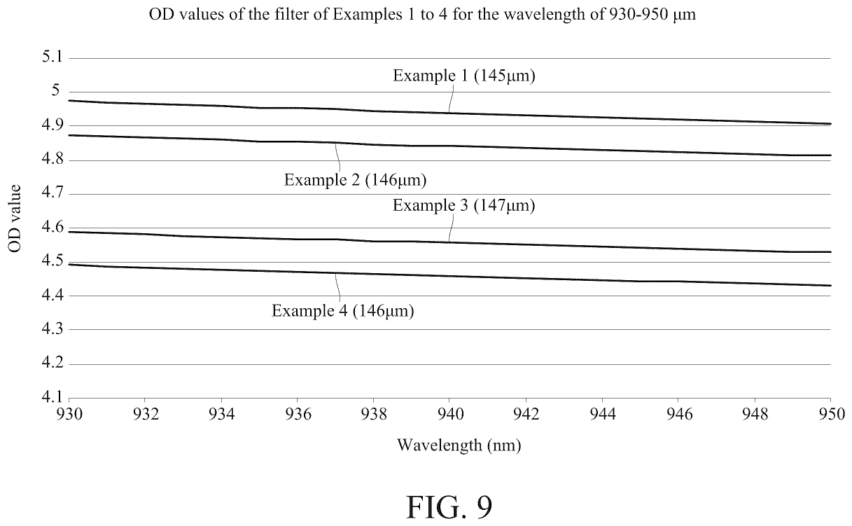

According to these results, for the incident light wavelength of 930-950 nm, the lens modules of the present disclosure had an excellent cutoff effect and can even achieve an OD value of 4.5 or more. To further display OD values of the lens modules of the present disclosure for the incident light wavelength of 930-950 nm, OD value curves of the lens modules of Examples 1 to 4 for the wavelength of 930-950 nm were overlaid in FIG. 9 according to the transmittance curves and data. On the other hand, the lens modules of the present disclosure had excellent transmittances for visible light, which had passbands overlaid with the wavelength of 350-850 nm, and the central wavelengths of the passbands were in the wavelength of 350-850 nm.

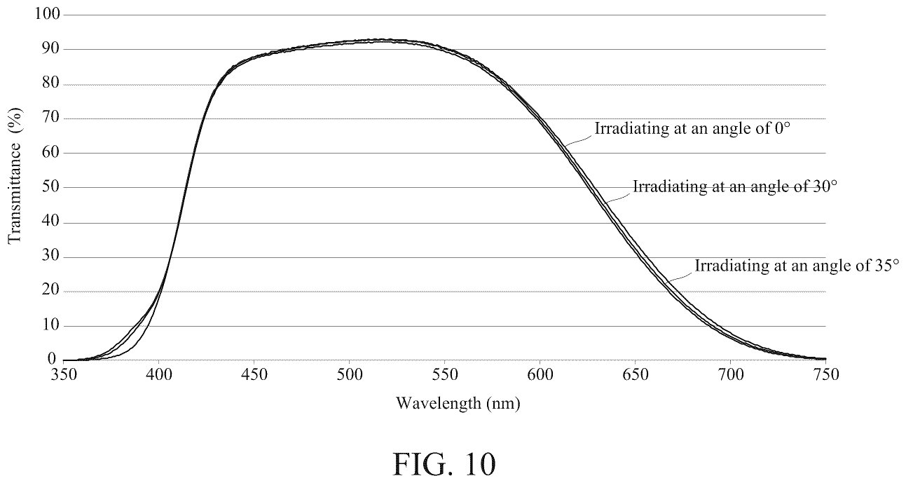

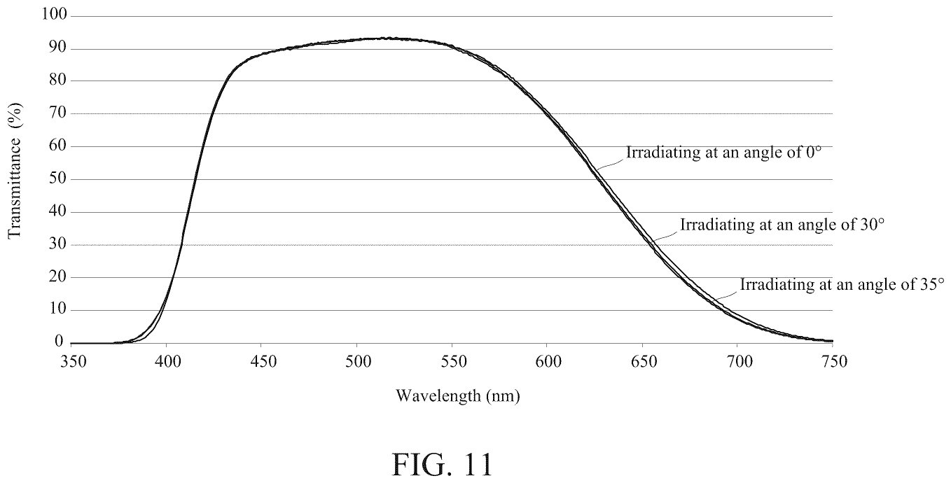

The level of shift can be observed from FIG. 10 which was the graph showing the transmittance curves of the lens module of Example 1 irradiated with incident light at different angles of 0°, 30°, and 35°. Similarly, FIG. 11 was the graph showing the transmittance curves of the lens module of Example 3 irradiated with incident light at different angles of 0°, 30°, and 35°. The results showed that the transmittance curves resulted from irradiating the lens modules at different angles were very similar, for example, the central wavelength of passbands shifted by 1.1 nm and 1.4 nm when the lens modules of Example 1 and Example 3 were irradiated at incident angles of 0° vs. 30°, respectively; and the central wavelength of passbands shifted by 1.7 nm and 1.9 nm when the lens modules of Example 1 and Example 3 were irradiated at incident angles of 0° vs. 35°, respectively. Compared to this, the central wavelength of passbands shifted by up to 9.6 nm when the lens module of Comparative Example 2 (prepared according to the method of Example 1 but contained no first absorption layer) was irradiated at incident angles of 0° vs. 30°, respectively; and the central wavelength shifted by up to 10.1 nm when it was irradiated at incident angles of 0° vs. 35°, respectively, exhibiting a high level of shift. It is known that a high level of shift will result in glare and ghosting. The lens module of the present disclosure significantly decreases glare and ghosting and improves the quality of images due to the small level of shift.

The embodiments and specific examples described above are not intended to limit the present disclosure. The technical features or schemes listed can be combined with one another. The present disclosure can be implemented or applied by other different execution modes. Details recorded herein can be altered or modified differently according to different viewpoints and applications without departing from the present disclosure.

What is claimed is:

1. A lens module with an integrated structure, comprising:
a first lens and a second lens disposed on outermost sides of the lens module, respectively;
a first substrate and a second substrate disposed on the first lens and the second lens, respectively;
an optical bonding layer formed on the first substrate or the second substrate and positioned between the first substrate and the second substrate; and
a first absorption layer and a second absorption layer disposed between the first substrate and the second substrate,
wherein the first absorption layer comprises:
a copper complex which is formed by a copper compound for providing copper ions, a phosphonic acid represented by Formula 1, and at least one phosphor-containing compound represented by Formulas 2 to 4, 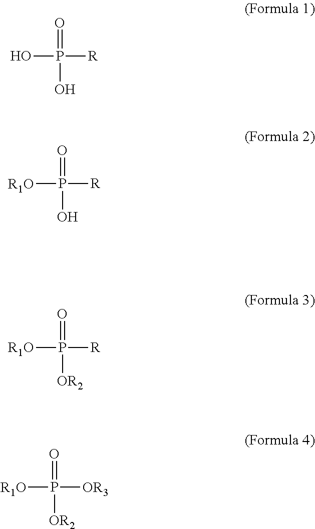
wherein R, R₁, R₂ and R₃ are each independently substituted or unsubstituted C₁-C₁₂ alkyl or substituted or unsubstituted C₆-C₁₂ aryl,
wherein the OD value of the first absorption layer for an incident light wavelength of 930-950 nm is greater than 4,
wherein the second absorption layer comprises an infrared absorption dye and an ultraviolet absorption dye.

2. The lens module of claim 1, wherein the substituted or unsubstituted C₁-C₁₂ alkyl is selected from the group consisting of methyl, ethyl, n-propyl, iso-propyl, n-butyl, sec-butyl, iso-butyl, tert-butyl; and the substituted or unsubstituted C₆-C₁₂ aryl is selected from the group consisting of phenyl, naphthyl and chlorophenyl.

3. The lens module of claim 1, wherein the first absorption layer has a haze of 0.4% or less.

4. The lens module of claim 1, wherein an X-ray photoelectron spectroscopy spectrum of the first absorption layer has at least one principal peak at binding energy of 930-940 eV.

5. The lens module of claim 4, wherein the at least one principal peak has counts per second of 4500 or more.

6. The lens module of claim 1, wherein the first absorption layer has a thickness of 25-150 μm.

7. The lens module of claim 1, wherein the first absorption layer has minimum transmittance of 80% or more for an incident light wavelength of 460-560 nm.

8. The lens module of claim 1, wherein the first absorption layer has minimum transmittance of 85% or more for an incident light wavelength of 460-560 nm.

9. The lens module of claim 1, wherein the optical bonding layer is an optical adhesive tape or an optical clear adhesive.

10. The lens module of claim 1, wherein the first substrate and the second substrate are made of glass.

11. The lens module of claim 1, wherein the first lens and the second lens are made of materials selected from the group consisting of glass, polycarbonates and polyacrylates.

12. The lens module of claim 1, wherein the second absorption layer comprises at least a sublayer comprising an infrared absorption dye and at least a sublayer comprising an ultraviolet absorption dye.

13. The lens module of claim 12, wherein the near-infrared absorption dye is at least one selected from the group consisting of azo compounds, di-iminium compounds, benzene dithiol metal complexes, squaraine compounds, cyanine compounds and phthalocyanine compounds.

14. The lens module of claim 12, wherein the ultraviolet absorption dye is at least one selected from the group consisting of azomethylene compounds, indole compounds, ketone compounds, benzimidazole compounds and triazine compounds.

15. The lens module of claim 1, further comprising a spacer disposed on the first substrate or the second substrate and surrounding the optical bonding layer.
